(19) United States
(12) Patent Application Publication
(10) Pub. No.: US 2017/0159824 A1
(43) Pub. Date: Jun. 8, 2017

(54) SEAL RINGS COMPRISING BORON CONTAINING CAST IRON

(71) Applicant: Caterpillar Inc., Peoria, IL (US)

(72) Inventors: Christopher Allen Barnes, Peoria, IL (US); Thomas Edward Pickert, Dunlap, IL (US)

(73) Assignee: Caterpillar Inc., Peoria, IL (US)

(21) Appl. No.: 14/963,050

(22) Filed: Dec. 8, 2015

(51) Int. Cl. F16J 15/34; C22C 38/56; C22C 38/54; C22C 38/00; C22C 38/44; C22C 38/04; C22C 38/02; B62D 55/088; C22C 38/46

(52) U.S. Cl. CPC F16J 15/3496; B62D 55/088; C22C 38/56; C22C 38/54; C22C 38/46; C22C 38/44; C22C 38/04; C22C 38/02; C22C 38/002

(57) ABSTRACT

A seal ring comprising a boron containing cast iron composition is disclosed. The cast iron composition particularly comprises each of boron, chromium and silicon in the following amounts: boron up to 1 wt. %; chromium up to 4 wt. %; and silicon up to 2 wt. %. The seal ring may be produced by melting a cast iron composition further comprising the foregoing alloying elements; pouring the melted alloy into a mold; cooling the melted alloy to form a cast iron seal ring; and separating the cast iron seal ring from the mold. The seal ring is typically used in the undercarriage of earth-working machines, such as in the drive train or power train of such machines.

### TECHNICAL FIELD

The present disclosure relates generally to seal rings, and more particularly to seal rings comprising boron containing cast iron that have enhanced performance characteristics, including improved wear and corrosion resistance.

### BACKGROUND

Many earth-working machines, such as loaders, tractors, and excavators, operate in extremely adverse environments often exposing the undercarriage components to various abrasive mixtures of water, dirt, sand, rock or chemical elements. Current undercarriage seal rings do not meet the targets for life in lower powertrain applications for mining and quarry products.

One attempt to produce cast seal rings that have increased performance is described in published. U.S. Patent Application No. U.S. 2012/0058710 to Young Jin Ma (“the '710 application”) that published on Mar. 8, 2012. The '710 application discloses a centrifugal casting method that produces a unique alloy microstructure over a traditional shell mold casting method, even if the same alloy cast iron is used. The centrifugal casting method described in the '710 application is not feasible because it requires large amounts of expensive alloying elements to achieve a desired microstructure, including increased amounts of nickel (Ni) for stabilizing an austenite phase, and molybdenum (Mo) for suppressing a martensite phase and unwanted carbides.

U.S. Pat. No. 3,758,296 (“the '296 patent”) to Thomas E. Johnson describes another example of a corrosion-resistant cast alloy that requires the use of expensive alloying elements, including: 26-48 wt. % of Ni; 30-34 wt. % Cr; and 4.0-5.25 wt. % Mo. While such an allow does achieve increased corrosion resistance, the cost associated with using these alloying elements makes the use of this alloy prohibitive in most commercial applications.

The boron containing east iron compositions is directed to overcoming one or more of the problems set forth above and/or other problems of the prior art.

### SUMMARY

In one aspect, the present disclosure is directed to a seal ring including a cast iron composition. The cast iron composition may include B, Cr, and Si in the following amounts: B in an amount up to 1.0 wt. %; Cr in an amount up to 4.0 wt. %; and Si in an amount up to 2.0 wt. %.

In a further aspect, the present disclosure is directed to a method of making a cast iron seal ring. The method may include melting an alloy composition comprising each of B, Cr, and Si in the following amounts: B in an amount up to 4.0 wt. %; Cr in an amount up to 4.0 wt. %; and Si in an amount up to 2.0 wt. %; pouring the melted alloy into a mold; cooling the melted alloy to form a cast iron seal ring; separating the cast iron seal ring from the mold; and machining the seal ring to at least one predetermined tolerance.

In yet another aspect, the present disclosure is directed to an undercarriage seal ring. The undercarriage seal ring may include a body that is generally cylindrical and extends along a longitudinal axis between a load end and a seal end; a seal flange, the seal flange disposed at the seal end of the body, the seal flange circumscribing the body and projecting radially from the body to a distal perimeter of the seal flange, the seal flange including a sealing face, the sealing face being annular and disposed adjacent the distal perimeter, wherein the seal ring is made from a cast iron composition, comprising: C: 2.8 to 4.2 wt. %; Mn: 0.50 to 0.70 wt. %; Ni: 3.5 to 6.0 wt. %; V: 0.03 to 0.10 wt %; Mo: 0.10 to 0.50 wt. %; B: greater than 0 and up to 1.0 wt. %; Cr: greater than 0 and up to 4.0 wt. %; Si: greater than 0 and up to 2.0 wt. %; P: up to 0.05 wt. %; 5: up to 0.05 wt. %; and the balance comprising Fe and incidental impurities. In an embodiment, the cast iron composition has a microstructure comprising more than 50 wt. % of martensite, austenite, and combinations thereof.

### BRIEF DESCRIPTION OF THE DRAWINGS

FIG. 1 is an axial end view of a seal ring according to the present disclosure.

FIG. 2 is an enlarged, fragmentary view of the seal ring of FIG. 1 corresponding to the location encompassed by circle VI in FIG. 1.

FIG. 3 is an enlarged, cross-sectional view taken along line VII-VII in FIG. 1.

FIG. 4 is a flow chart illustrating steps of an embodiment of a method of making a seal ring as described herein.

### DETAILED DESCRIPTION

There are disclosed embodiments of boron containing cast iron compositions for seal rings with enhanced performance characteristics. There are also disclosed methods of making a seal ring. In an embodiment, there is disclosed a boron containing cast iron composition comprising each of boron (B), chromium (Cr), and silicon (Si) in the following amounts: B up to 1 wt. %, such as an amount ranging from 0.25 to 0.75 wt. %; Cr in an amount up to 4 wt. %, such as an amount ranging from 1 to 4 wt. %; and Si in an amount up to 2 wt. %, such as an amount ranging from 0.5 to 1.9 wt. %. Small additions of B, such as less than 1 wt. %, provides beneficial effects on the resulting alloy, including promoting CrB in kinetics. However, B in an amount greater than 1 wt. % leads to undesirable effects on the alloy, including increasing shrinkage tendency.

In an embodiment, the alloy also includes carbon (C) in an amount ranging from 2.8 to 4.2 wt. %; manganese (Mn) in an amount ranging from 0.50 to 0.70 wt. %; nickel (Ni) in an amount ranging from 3.5 to 6.0 wt. %; vanadium (V) in an amount ranging from 0.03 to 0.10 wt. %; molybdenum (Mo) in an amount ranging from 0.10 to 0.50 wt. %; phosphor (P) in an amount up to 0.05 wt. %; sulfur (S) in an amount up to 0.05 wt. %, with the balance comprising iron (Fe) and incidental impurities.

In an embodiment, the cast iron composition has a microstructure comprising less than 50 wt. % carbide, such as between 5 to 45 wt. % carbide, or 10 to 40 wt. % carbide, or even 15 to 35 wt. carbide, or any combination of these ranges, such as 35 to 40 wt. % carbide.

In an embodiment, the cast iron composition has a microstructure comprising more than 50 wt. % of martensite, austenite and combinations thereof. For example, in various embodiments, the cast iron composition has a microstructure comprising martensite, austenite and combinations thereof in amounts ranging from 50 to 95 wt. %, 55 to 90 wt. %, 60 to 85 wt. %, 70 to 80 wt %, or any combination of these ranges, such as 80 to 95 wt. %. As described in more detail below, the alloy composition described herein can be heat treated after casting to allow a majority of this phase to comprise martensite. In an embodiment, at least 75 wt. %, such as 80 to 95 wt. % of this phase comprises martensite. martensite. In another embodiment, substantially the entire phase, e.g., at least 99% of this phase is martensite.

In an embodiment, a seal ring can be made from an alloy described herein using any suitable method of making a seal ring, such as mold casting, sand die, and centrifugal casting, in embodiments, the seal ring includes a body and a seal flange. The body is generally cylindrical and extends along a longitudinal axis between a load end and a seal end. The seal flange is disposed at the seal end of the cylindrical body. The seal flange circumscribes the body and projects radially from the body to a distal perimeter of the seal flange. The seal flange includes a sealing face which is annular and disposed adjacent the distal perimeter.

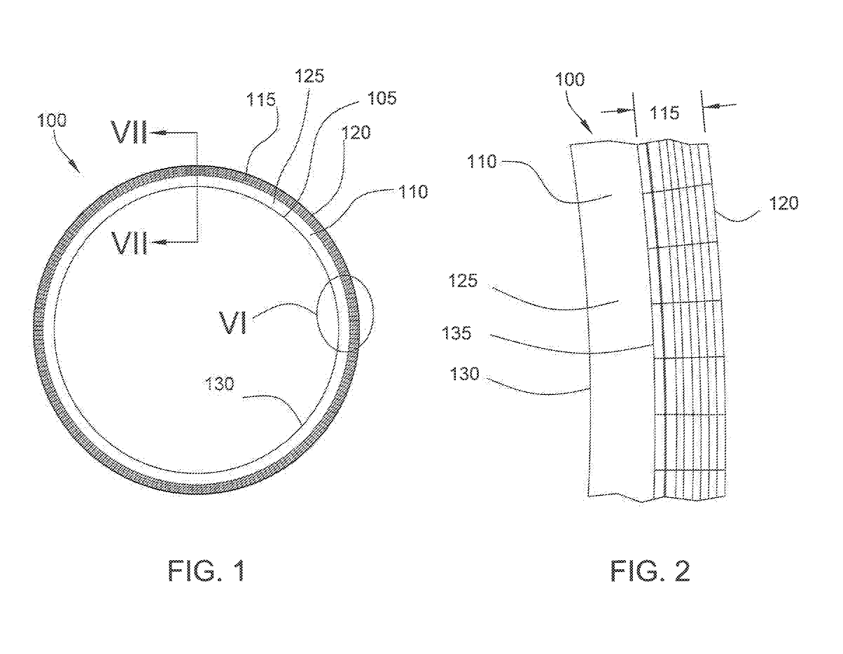

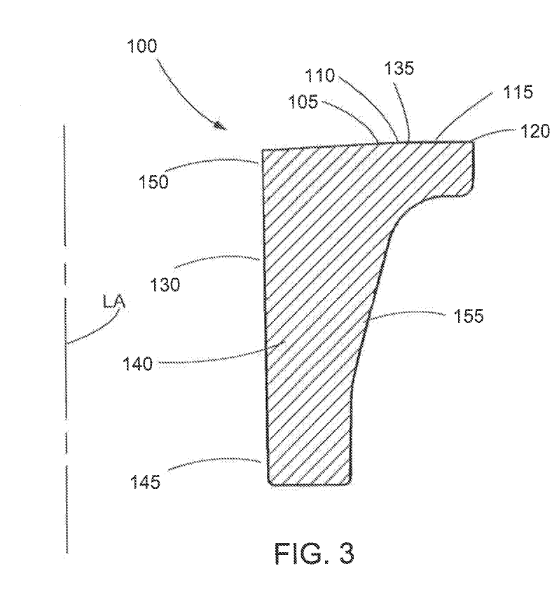

A more detailed description of the body of the seal ring including the steps of an embodiment of a method of making it is provided in the FIGS. 1-4. Referring to FIGS. 1 and 2, a seal ring 100, which is an example of an embodiment according to the present disclosure, is shown. The seal ring 100 is in the shape of an annulus. The seal flange 105 includes the sealing face 110. The sealing face 110 includes the sealing band 115 disposed adjacent the outer perimeter 120 of the seal flange 105 and an inner relieved area 125 disposed between the sealing band 115 (which is shown as a hatched area in FIGS. 1 and 2 for illustrative purposes) and an inner perimeter 130 of the seal ring 100. The inner relieved area 125 can be tapered between the sealing band 115 and the inner perimeter 130 such that the inner perimeter 130 is axially displaced from the sealing band 115.

Referring to FIG. 3, the seal ring 100 includes a cylindrical body 140 and the seal flange 105. The cylindrical body 140 extends along the longitudinal axis “LA” between the load end 145 and the seal end 150, which is in opposing relationship to the load end 145. The cylindrical body 140 includes the inner perimeter 130 which is substantially cylindrical and the majority of the inclined loading surface 155, which is in outer, radial spaced relationship to the inner perimeter 130.

The seal flange 105 is disposed at the seal end 150. The seal flange 105 projects radially from the cylindrical body 140 to the outer perimeter 120 thereof. The sealing face 110 is disposed on the seal flange 105 and extends radially with respect to the longitudinal axis “LA.” The sealing band 115 can be substantially flat in cross-section between an inner radial edge 135 and the outer perimeter 120 (also shown in FIG. 2). In an embodiment, the sealing band 115 can include an outer relieved area disposed adjacent the outer perimeter 120 that is tapered.

### EXAMPLE

In the Example, seal rings comprising an alloy described herein were made and compared to a commercially available alloys, which are referred to as C1-C4. The compositions of the various alloys are set forth below in Table I. As shown, the only commercial alloy containing boron, has lower amounts of both silicon and boron.

TABLE I
Chemistry Targets for Casting Trials

| | C1 | C2 | C3 | C4 | Inventive |
|---|---|---|---|---|---|
| Element | (wt %) | (wt %) | (wt %) | (wt %) | (wt %) |
| Carbon | 4.10 | 3.30 | 3.30 | 3.40 | 3.30 |
| Silicon | 2.00 | 0.80 | 0.80 | 0.60 | 1.90 |
| Manganese | 0.60 | 0.60 | 0.60 | 0.60 | 0.60 |
| Chromium | 2.30 | 1.40 | 1.40 | 1.40 | 1.40 |
| Nickel | 3.80 | 3.80 | 3.80 | 3.80 | 3.80 |
| Molybdenum | 0.40 | 0.10 | 0.10 | 0.10 | 0.10 |
| Vanadium | 0.40 | 0.60 | 0.60 | 0.60 | 0.60 |
| Phosphor | 0.05 | 0.05 | 0.05 | 0.05 | 0.05 |
| Sulfur | 0.05 | 0.01 | 0.01 | 0.01 | 0.01 |
| Boron | 0.00 | 0.50 | 0.00 | 0.00 | 0.75 |

| | |
|---|---|
| Iron | Balance |

The alloys were melted in a production furnace and brought to a pour temperature of 1350° C. The melted alloy was used in a static casting process to form seal rings of the same nominal size and geometric configuration. The seal rings were machined to tolerance using production lathes with standard tool inserts, and prepared for pressure velocity (PV) testing.

Next, the seal rings were tested for pressure velocity (PV). In these tests, a test fixture design was used that held the seal rings in spatial and orientation relationship, as per their ordinary and intended use, including the test fixture providing a predetermined seal gap. The test fixture contained a seal cavity which was filled to a center fill line with oil at ambient temperature. The sealing faces of the contacting seal rings were subjected to an axial pressure, and one seal ring was rotated relative to the other seal ring at an initial rotational velocity. All of the seal rings were subjected to PV testing with the same load and seal gap settings.

In particular, the testing conditions comprised a faceload of 1.2 N/mm and a cavity pressure of 10.0 KPa. The PV testing, specifically the rotation of the seal ring, was conducted according to the following cycle as set forth below in Table II:

TABLE II
Cycle for PV Testing

| Point of Cycle | Rotational Speed and Time |
|---|---|
| 1 (Start) | 0 rpm |
| 1-2 | Accelerate to 50 rpm at 40 rpm/sec |
| 2-3 | Forward Time, 240 sec at 50 rpm |
| 3-4 | Decelerate to 0 rpm at −40 rpm/sec |
| 4-5 | Dwell Time, 60 sec at 0 rpm |
| 5-6 | Accelerate to −50 rpm at −40 rpm/sec |
| 6-7 | Reverse Time, 240 sec at −50 rpm |
| 7-8 | Decelerate to 0 rpm at 40 rpm/sec |
| 8-9 | Dwell Time, 60 sec at 0 rpm |

In the PV testing described above, the seal rings were monitored for failure using a thermocouple configured to detect failures such as scoring, galling, and leaks. Weep was defined by the instant that dyed oil was present at the sealing face. Leak was defined by any amount of oil leaving the sealing region. The PV testing showed that seal rings made from alloys of the present disclosure exhibited the same or better performance (higher PV values) in PV testing as conventional seal rings, including PV values up to 1200 KN/mm−mm/min.

### INDUSTRIAL APPLICABILITY

The disclosed boron containing cast iron alloy for a seal ring, a seal ring for a seal assembly, and a method of making a seal ring may be applicable to the lower powertrain of machines and equipment used in harsh environments, such as mining and quarry products. A seal ring constructed according to principles of the present disclosure generally exhibit improved life, improved scoring pressure velocity, acceptable corrosion resistance, and ease of manufacturing. The seal rings disclosed herein can be offered on new equipment, or can be used to retrofit existing equipment.

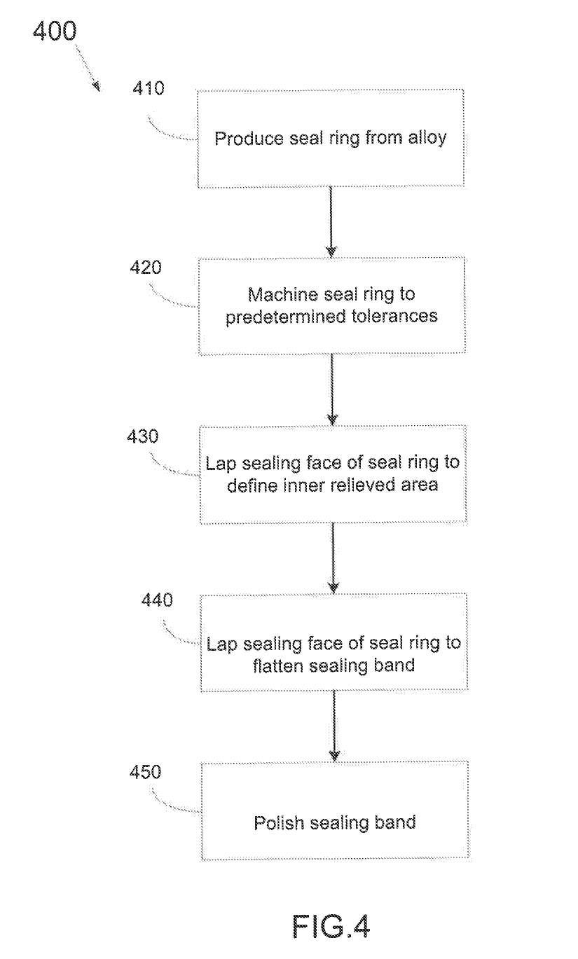

In an embodiment, there is described a method for preparing a seal ring according to the present disclosure. Referring to FIG. 4, steps of an embodiment of a method 400 for preparing a seal ring for a seal assembly as disclosed are shown. The seal ring is produced from an alloy following principles of the present disclosure (step 410). The seal ring is machined to at least one predetermined tolerance (step 420). The sealing face of the seal ring is lapped to define an inner relieved area (step 430). The sealing face of the seal ring is lapped to flatten a sealing band (step 440). The scaling band is polished (step 450).

The seal ring can be produce in step 410 using any suitable technique, such as by being stamped and formed or cast, for example. In an embodiment, the seal ring is produced by a casting technique, such as by a static mold casting or centrifugal casting. A casting technique includes melting an alloy composition as described herein, e.g., such as an alloy comprising each of B, Cr, and Si in the following amounts B in amounts up to 1 wt. %, Cr in amounts up to 4.0 wt. %, and Si in amounts up to 2.0 wt. %.

The method according to this embodiment further comprises pouring the melted alloy into a mold at a temperature ranging from 1370° C. to 1482° C. The melted alloy is then cooled in the mold to form a cast iron seal ring, separating the cast iron seal ring from the mold, and machining the seal ring to at least one predetermined tolerance.

While not shown in FIG. 4, it is understood that the method of preparing a seal ring according to the present disclosure may further comprise a step for heat treating the cast iron seal to change at least one physical or mechanical property of the alloy. For example, the method may comprise heat treating the cast alloy to change the microstructure to comprise a desired carbide phase and one or more desired crystalline phases chosen from martensite and austenite.

In an embodiment, the method comprises heat treating the cast iron composition to achieve a microstructure comprising less than 50 wt. % carbide, such as between 5 to 45 wt. % carbide, or 10 to 40 wt. % carbide, or even 15 to 35 wt. % carbide, or any combination of these ranges, such as 35 to 40 wt. % carbide.

In an embodiment, the method comprises heat treating the cast iron composition to achieve a microstructure having at least 50 wt. % of rnartensite, austenite and combinations thereof. For example, in various embodiments, the method comprises heating treating the cast iron composition to achieve a microstructure comprising martensite, austenite and combinations thereof in amounts ranging from 50 to 95 wt. %, 55 to 90 wt. %, 60 to 85 wt. %, 70 to 80 wt. %, or any combination of these ranges, such as 80 to 95 wt. %. The method comprises heating treating the cast iron composition to achieve a microstructure to achieve primarily martensite, such as at least 75 wt. m.artensite, such as 80 to 95 wt. % martensite, or even substantially all martensite, e.g., at least 99% of this phase is martensite. in an embodiment, phase identification can be determined by Scanning Electron Microscopy (SEM) analysis.

As defined herein, heat treating comprises an annealing step, a tempering step, or both and annealing and tempering step. In an embodiment, the annealing step comprises heating the cast iron seal to a temperature ranging from 700 to 800° C., such as 750° C., for a time ranging from 1 to 3 hours, such as 2 hours, followed by cooling to less than 200° C., such as 150° C. at a rate ranging from 25 to 35° C. per hour, such as 30° C. per hour. In an embodiment, the tempering step comprises heating at a temperature from 200 to 250° C., such as 225° C. for a time ranging from 1 to 3 hours, such as 2 hours.

Either prior to or after heat treating, the seal ring can be machined as shown in step 420 of FIG. 4. In step 420, the seal ring can be machined by any suitable technique, such as by using a lathe for lathe-turning and/or grinder for grinding operations, for example. The seal ring can be machined such that the thickness of the seal flange is within a predetermined tolerance, the seal ramp angle is within a predetermined tolerance, and other dimensional tolerances are met, for example. In an embodiment, the resulting seal ring has a hardness ranging from 60 HRC to 70 HRC, such as 68 HRC.

In addition to the hardness properties, the seal ring made according to the present disclosure exhibits a scoring pressure velocity ranging from 300-1200 KN/mm−mm/min, such as from 600 to 900 KN/mm−mm/min.

In step 430, the sealing face can be lapped using any suitable technique, such as with a spherical lap, for example, to define the inner relieved area. In step 440, the sealing face can be lapped using any suitable technique, such as with a flat lap, for example, to flatten the sealing band. In embodiments, the sealing band can be polished in step 440 using any suitable technique.

It will be apparent to those skilled in the art that various modifications and variations can be made to the disclosed alloy and method of forming the alloy into a finished part without departing from the scope of the disclosure. Alternative implementations will be apparent to those skilled in the art from consideration of the specification and practice disclosed herein. It is intended that the specification and examples be considered as exemplary only, with a true scope of the disclosure being indicated by the following claims and their equivalents.

What is claimed is:

1. A seal ring, comprising a body having a cast iron composition of B, Cr, and Si in the following amounts:
B: up to 1 wt. %;
Cr: up to 4 wt. %; and
Si; up to 2 wt. %.

2. The seal ring of claim 1, wherein the B is present in an amount ranging from 0.25 to 0.75 wt. %.

3. The seal ring of claim 1, wherein the Cr is present in an amount ranging from 1 to 4 wt. %.

4. The seal ring of claim 1, wherein the Si is present in an amount ranging from 0.5 to 1.9 wt. %.

5. The seal ring of claim 1, wherein the cast iron composition further includes:
C: 2.8 to 4.2. wt. %;
Mn: 0.50 to 0.70 wt. %;
Ni: 3.5 to 6.0 wt. %;
V: 0.03 to 0.10 wt. %;
Mo: 0.10 to 0.50 wt. %;
P: up to 0.05 wt. %;
S: up to 0.05 wt. %; and
the balance comprising Fe and incidental impurities.

6. The seal ring of claim 1, wherein the cast iron composition has a microstructure of less than 50 wt. % carbide.

7. The seal ring of claim 1, wherein the cast iron composition has a microstructure of more than 50 wt. % of martensite, austenite and combinations thereof.

8. The seal ring of claim 1, wherein at least a surface of the cast iron composition has a Rockwell C hardness ranging from 60 to 70.

9. The seal ring of claim 1, wherein the cast iron composition exhibits a scoring pressure velocity ranging from 300-1200 KN/mm−mm/min.

10. The seal ring of claim 1, wherein:
the body is generally cylindrical and extends along a longitudinal axis between a load end and a seal end;
the seal ring further includes the seal flange disposed at the seal end of the body, the seal flange circumscribing the body and projecting radially from the body to a distal perimeter of the seal flange, the seal flange including a sealing face that is annular and disposed adjacent the distal perimeter.

11. A method of making a cast iron seal ring, comprising:
melting an alloy composition comprising each of B, Cr, and Si in the following amounts:
B: up to 1 wt. %;
Cr: up to 4 wt. %; and
Si: up to 2 wt. %;
pouring the melted alloy into a mold;
cooling the melted alloy to form a body;
separating the body from the mold; and
machining the body to at least one predetermined tolerance.

12. The method of claim 11, wherein the alloy composition further includes:
C: 2.8 to 4.2 wt. %;
Mn: 0.50 to 0.70 wt. %;
Ni: 3.5 to 6,0 wt. %;
V: 0.03 to 0.10 wt. %;
Mo: 0.10 to 0.50 wt. %;
B: 0.25 to 0.75 wt. %;
Cr: 1.0 to 4.0 wt. %;
Si; 0.5 to 1.9 wt. %;
P: up to 0.05 wt. %;
S: up to 0.05 wt. %; and
the balance comprising Fe and incidental impurities.

13. The method of claim 11, further comprising heat treating the body to change at least one physical or mechanical property of the alloy.

14. The method of claim 13, wherein said heat treating results in the alloy having a microstructure comprising more than 50 wt. % of martensite, austenite and combinations thereof.

15. The method of claim 13, wherein heat treating comprises an annealing step, a tempering step, or both and annealing and tempering step.

16. The method of claim 15, wherein said annealing step comprises heating the body to a temperature ranging from 700 to 800° C. for a time ranging from 1 to 3 hours, followed by cooling to less than 200° C. at a rate ranging from 25 to 35° C. per hour.

17. The method of claim 16, wherein said tempering step comprises heating at a temperature from 200 to 250° C. for a time ranging from 1 to 3 hours.

18. The method of claim 11, wherein said pouring occurs at a temperature ranging from 1370° C. to 1482° C.

19. The method of claim 11, wherein said machining the body to at least one predetermined tolerance comprises: lapping a sealing face of the body to define an inner relieved area; and lapping the sealing face to flatten a sealing band.

20. An undercarriage seal ring comprising:
a generally cylindrical body extending along a longitudinal axis between a load end and a seal end;
a seal flange disposed at the seal end of the generally cylindrical body, the seal flange circumscribing the generally cylindrical body and projecting radially from the generally cylindrical body to a distal perimeter of the seal flange, the seal flange including an annular sealing face disposed adjacent the distal perimeter, wherein:
the seal ring is made from a cast iron composition, comprising:
C: 2.8 to 4.2 wt. %;
Mn: 0.50 to 0.70 wt. %;
Ni: 3,5 to 6,0 wt. %;
V: 0.03 to 0.10 wt. %;
Mo: 0.10 to 0.50 wt. %;
B: greater than 0 to 1.0 wt. %;
Cr: greater than 0 to 4.0 wt. %;
Si: greater than 0 to 2.0 wt. %;
P: up to 0.05 wt. %;
S: up to 0.05 wt. %; and
the balance comprising Fe and incidental impurities; and
the cast iron composition has a microstructure comprising more than 50 wt. % of martensite, austenite, and combinations thereof.
